(19) United States
(12) Patent Application Publication
(10) Pub. No.: US 2017/0273505 A1
(43) Pub. Date: Sep. 28, 2017

(54) Non-Electric, Non-Steaming Stove Top/Grill Adapter and Method of Use

(71) Applicant: George S. MacDonald, Carnegie, PA (US)

(72) Inventor: George S. MacDonald, Carnegie, PA (US)

(21) Appl. No.: 15/080,857

(22) Filed: Mar. 25, 2016

(51) Int. Cl. A47J 37/06

(52) U.S. Cl. CPC A47J 37/06; A23L 1/01; A23V 2002/00

(57) ABSTRACT

A non-electric adapter for cooking food over a plurality of burners to an electric or gas stove comprises: (i) a base frame having a substantially rectangular shape with side handles at opposed ends, a plurality of vertical wire rods, a left and right grate end rod and a forward curved rod for holding a drip tray; (ii) a griddle with a flat upper surface onto which food is placed for cooking, said griddle being slanted between about 7 to 15 degrees from planar when used for cooking and having a flap at each front edge corner for resting on a grate end rod of the base frame; and (iii) a cover lid hinged to a rear edge of the griddle and overlapping its front edge by about 1.5 to 2.5 inches at its maximum width when lowered over the griddle. A method for cooking with this adapter is also disclosed.

### BACKGROUND OF THE INVENTION

1. Field of the Invention

This invention relates to cooking grills. More particularly, it relates to a grill adapter for positioning over one or more burners of an electric or gas stove to achieve the effect of outdoor grilled foods without electricity and/or steaming. It further relates to a method for using such an adapter to grill meats and other foods.

Grilling is a popular method of cooking food items due to the unique flavors and textures that it imparts to food items. Grilling can be performed out-of-doors with a charcoal or gas grill. It can also be performed indoors with an indoor grill having a dedicated heat source such as the line of electric-powered, George Foreman-style grills.

2. Description of the Prior Art

Many families desire to grill meats and other foods in their kitchens due to harsh weather conditions and/or a limited amount of outdoor space that minimizes the use of certain barbeques. One advantage of using a grill over a typical frying pan is its ability to reduce or eliminate fat from the cooking process.

Multi-purpose implements have been provided which cook or bake food with convection air. Some add moisture to the cooking area to prevent the food from drying out. Prior art devices include those shown and described in U.S. Pat. Nos. 3,301,172, 4,454,805, 4,694,816, and 4,976,252.

Still other relevant disclosures include the multi-purpose cooking device of U.S. Pat. No. 7,059,318, and the side flame stove top grill of Published U.S. Application No. 20120216686.

Although the prior art is replete with various types of multi-purpose cooking implements, there still exists a need for an improved non-electric, non-steaming device that has the ability to employ heat from a common cooking heat source for grilling meats and other food products from the convenience of one's indoor gas/electric stove.

### BRIEF SUMMARY OF THE INVENTION

The present invention will work on the gas or electric burner of a stove/grill. It can fit over a single burner arrangement or, when rotated ninety degrees in either direction, over the front AND rear burners of a stove (on the same side of that gas or electric range). It collects fat drippings and juices before they might otherwise reach the burner(s). The base of the grill includes a double handled wire frame (or grate) with a collection pan that can be removed, cleaned and replaced for reuse. The angled griddle has a plurality of nubs (or slight protrusions) in a line at or near its front edge for preventing foodstuffs from sliding too far forward. Opposed front corners of this griddle have inward indentations (or an inwardly beveled tooth) that allow the griddle to rest safely on an upwardly protruding, raised rod from each forward end of the underlying wire frame/grate. The cover/lid is hinged to the rear edge of the griddle and includes an easy-to-use, less temperature conducting/more temperature resistance top handle. Preferably, a temperature gauge is further included in this cover/lid that intentionally overlaps (or “over-bites”) a curved recess in the front edge of the griddle so that heat from the gas/electric burner may circulate hot air about the food product being grilled. In so doing, this invention will provide a better quality of food product, with a grilled taste and without supplemental power supply (electric OR steam) in an efficient, economical way.

The present invention is a grill adapter for positioning on a gas or electric stove top. The grill is made of three main parts: a grated, wire frame base member with handles at opposed ends, an angled central griddle and a lid with an overlapping front edge. The base member has a removable pan at its forward edge for catching grease, fat and other drippings from the food product being grilled. A front edge to the hinged cover/lid purposefully extends beyond the forward edge of the griddle, that is preferably inwardly scalloped, so as to allow waves of hot air from the burner to pass over the griddle and food placed thereon. All three main parts can be easily disassembled from one another for convenient cleaning.

Therefore, it is the main object of this invention to provide a device for grilling food over a typical stovetop burner, whether gas or electric. It is still another object to provide a stovetop grill adapter made of three main parts that are easy to manufacture, use, clean and then store when not in use.

The present invention satisfies the need for such an improved cooking device and comprises a wire framed base, a cooking griller plate with toothed front corners for resting (potentially locking) on an upwardly protruding longitudinal rod component of the base, and a hinged cover lid with temperature resistant handle and temperature gauge/indicator built in. The griller plate (or griddle) and lid hinged thereto rest on and are supported by the base frame that purposefully aligns with the one or two burners from the indoor heat source (either a gas or electric range top).

This cooking adapter provides the ability to perform direct contact grilling of food items: (a) indoors, (b) on a conventional stove or other suitable cooking environment, (c) using any suitable external source of heat. The handled wire base holds a griddle/griller on which food items are placed for “cooking” an optimum distance from the heat source. The lid over this base and griddle combination is supported a distance above the heat source yet permits air flow from that heat source to safely circulate thereunder while reducing the possibility of unnecessary, uninentional damage to that heat source.

The griddle/grilling plate is configured to efficiently transfer heat from the heat source to the food items and impart, when desired, the appearance typically associated with cooking on an outdoor grill and/or barbeque. With the forward nubs/protrusions adjacent the drip pan, fats and oils released from the foods can be drained away and collected for disposal thus providing a further health benefit through use of this invention.

The adaptor of this invention is purposefully configured to provide an angled (or slanted) cooking surface relative to the base frame on which it rests. The front end to its griddle component is preferably inwardly scalloped (or curved) to better accommodate the drip pan held by the base frame immediately adjacent this forward curved edge. A plurality of nubs on one forward edge of this same griddle/griller allows drainage of fluids (especially fats and greases) away from the meats or other food items being prepared thereon. Such a configuration prevents liquid by-product of the cooking process from falling off the griddle, through the base frame and onto the burner(s) of the gas/electric stove to assist with cleaning and maintenance of the adapter.

### BRIEF DESCRIPTION OF THE DRAWINGS

Further features, objectives and advantages of this invention shall be made clearer with the following detailed description of preferred embodiments made with reference to the accompanying drawings in which:

FIG. 1 is a top perspective view of an assembled grill adapter according to one embodiment of the present invention;

FIG. 2 is a top perspective, fragmented view of the grill adapter from FIG. 1;

FIG. 3 is a top plan view of the intermediate griddle from the grill adapter of FIGS. 1 and 2;

FIG. 4 is a front plan view of the same griddle from FIG. 3;

FIG. 5 is a right side view of the same griddle from FIGS. 3 and 4;

FIG. 6 is a top perspective view focusing on the same griddle component from FIGS. 3 through 5;

FIG. 7 is a top perspective view of the cover/lid to the adapter of FIGS. 1 and 2;

FIG. 8 is a top plan view of the cover/lid from FIG. 7;

FIG. 9 is a rear plan view of the cover/lid from FIGS. 7 and 8;

FIG. 10 is a right side view of the cover/lid from FIGS. 7 through 9; and

FIG. 11 is a bottom plan view showing one preferred degree of lid overlap with the underlying griddle.

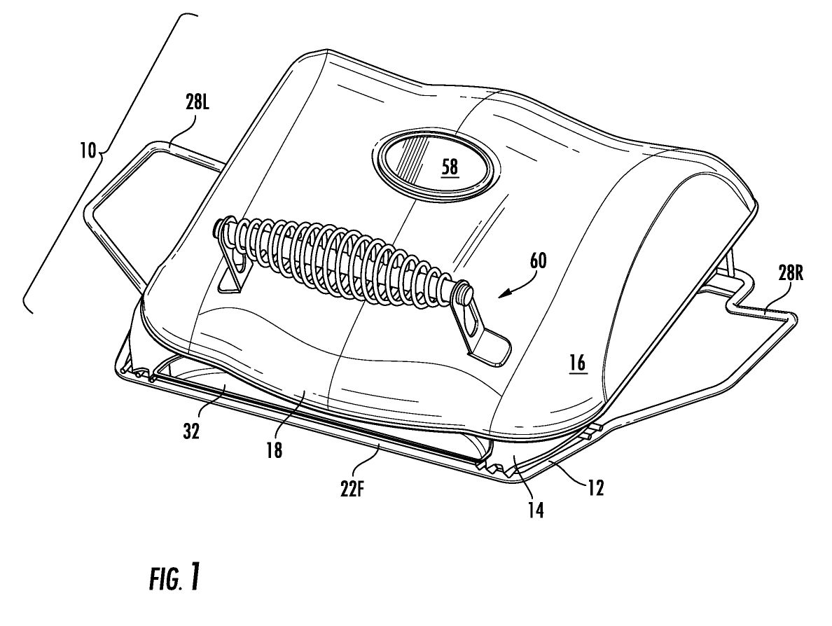

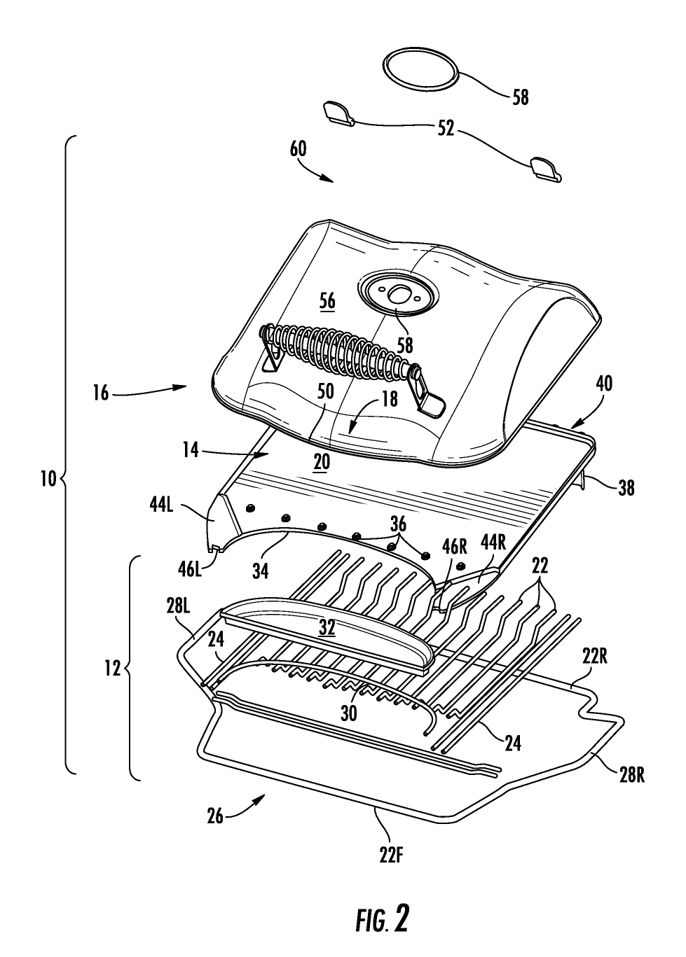

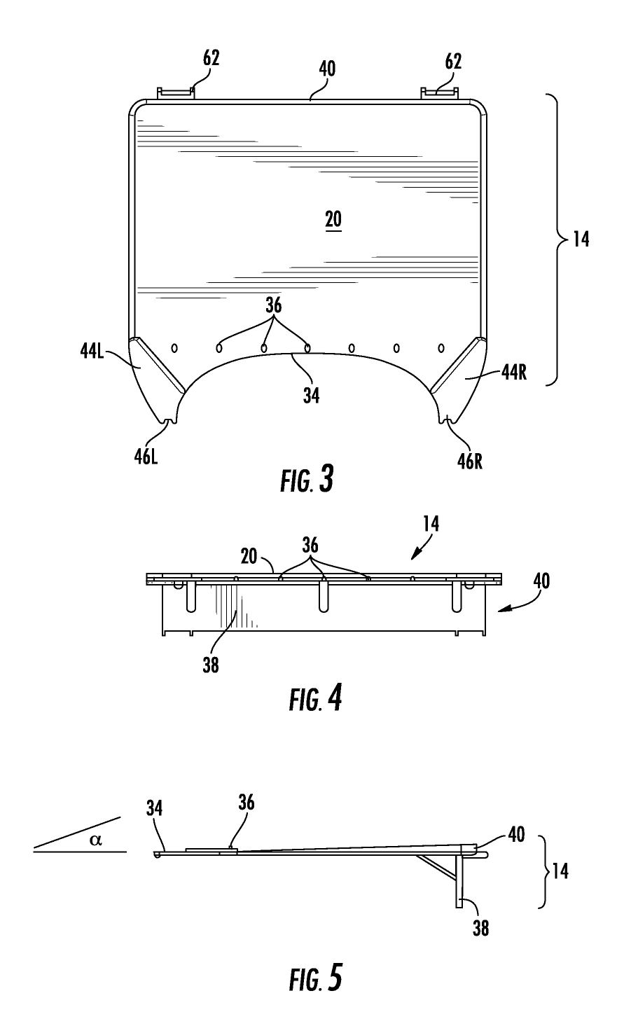

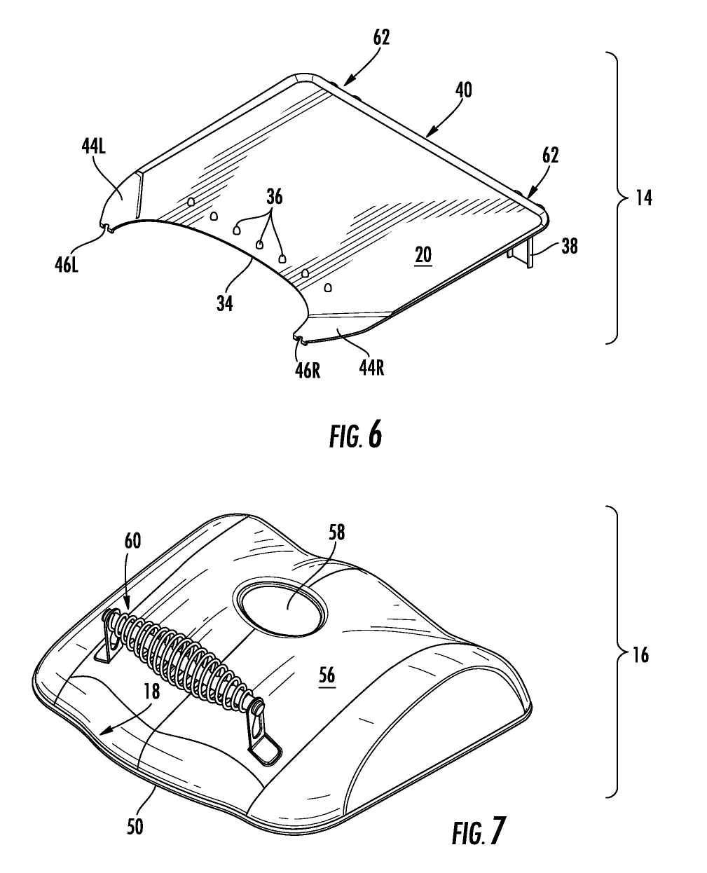

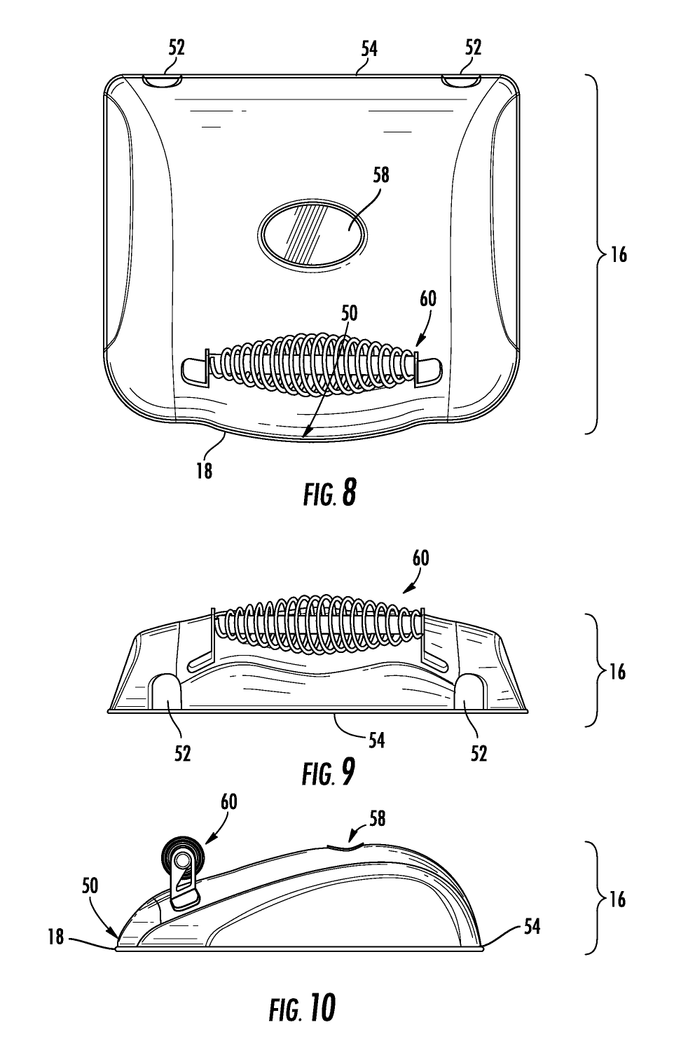

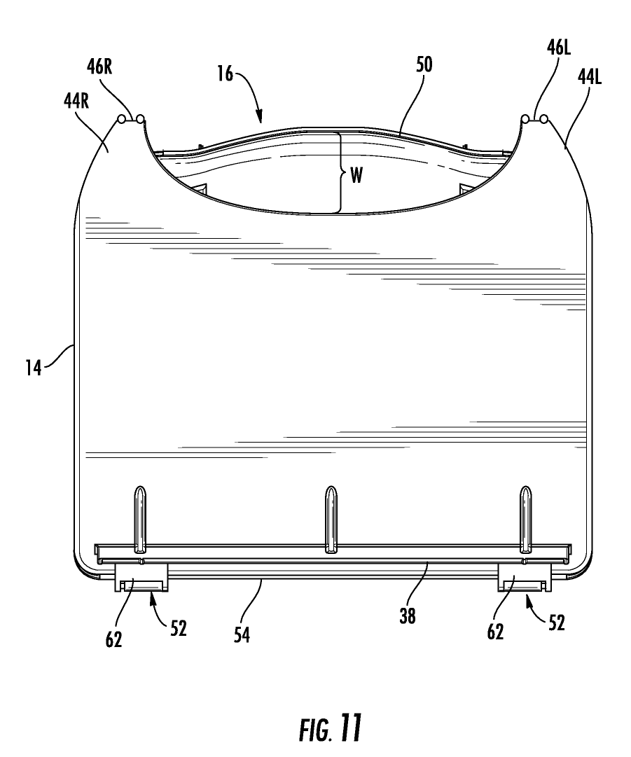

### DESCRIPTION OF PREFERRED EMBODIMENTS

In the promotion of this invention, consumers are being told:
Do you love fresh grilled meats, poultry, and other foods? There is nothing like the taste of a grill to plate meal. Getting that “perfect” grilled taste without the burn is extremely difficult, however. Now, with Perfect Grill™, get the grilled taste you love without the risk of burns, flame flare-ups, or other food-ruining elements!

This new product is a new flat top griddle that can be used virtually anywhere! Use it on your grill, grill tops, and even on your stove. The grill features a flat cooking surface, a comfortable spring handle, a removable lid, along with a grate and drip pan. The included drip pan drains off excess grease creating an even healthier meal! The griddle comes with an optional lid hook, so that you can lift the griddle's lid without risk of burns! Safety and ease of use all in one!

Unlike other grilling methods, the griddle's flat cooking surface is unique in that it acts as a barrier between your grill or other cooking surfaces, protecting your food from ruin due to flare-ups that regularly occur on conventional grills and stoves. Perfect Grill™ infuses your foods with that flame-cooked flavor every time you use it, even when cooking on a stove top! And thanks to its unique design, it is both easy to clean and store! Its multi use functionality makes it great for at use at home, picnics, camping, and so much more. Your friends and family will be impressed every meal.

Kick burnt and over-cooked foods to the curb! Get perfectly delicious, straight-from-the-grill flavor with Perfect Grill™. Once you've tried it, you'll never grill any other way!

The adapter is constructed with a cast then coated aluminum griddle, a stamped and coated steel lid, a bent and welded steel wire grate, a stamped steel drain tray, a bent steel lid tool, and additional small stamped steel components.

Referring to the accompanying FIGS., there is shown a first embodiment of grill adapter, generally 10, made from various component parts. Particularly, the present invention comprises a base frame/grate 12, griddle/cooking plate 14 and lid/cover 16. As depicted, base frame 12 forms a grate-like support on which both griddle 14 and lid 16 rest when in use (over a stove top/burner—gas OR electric, not shown).

The main components of adapter 10 can be used with other components not part of the device for the food preparation task at hand. For example, base frame 12, griddle 14 and lid 16 can be placed directly over or onto various heat sources such as a conventional charcoal or gas grill.

The lid 16 provides the unit with some assistance in convection cooking, i.e., with the passage of hot air beneath a forward extending lip region 18 of the lid and passing directly over the top surface 20 of griddle 14 with its meat and/or other food products being cooked thereon.

The base 12, itself, consists of a plurality of vertically extending wire grate rods 22. Though twelve such rods 22 are shown extending between grate ends 24, it is understood that this component of the invention can also be constructed with greater or fewer such rods 22 in the alternative.

The vertical rods 22 connect at their respective front 22F and rear 22R ends to a main frame element 26 that is somewhat rectangular in appearance but for some integrally formed handles 28L and 28R on opposed side ends. One uses these latter handles 28L and 28R for proper positioning of an adapter unit 10 over the heat source of preference, a charcoal/gas grill, internal gas or electric stove burner, none of which are shown herewith. To the extent a typical indoor stove has four burners, two forward and two rearward, preferred embodiments of main frame element 26 are sized to fix over two adjacent stove burners, either the two front or two rear, or atop a front and rear burner combination after the whole unit has been rotated a full 90 degrees in either direction.

Main frame element 26 further includes a curved or scalloped support element 30 that is meant to hold in place a drip or drain tray 32 situated at the forward most, front edge 34 of griddle 14. At or near that forward most front edge 34, on the top surface 20 of griddle 14, there is included a plurality of spaced protrusions or nubs 36 designed to prevent foodstuff from sliding too far forward along griddle 14 when in use. Though seven such nubs are shown for the size and overall shape of the griddle depicted in the accompanying drawings, it is understood that no fewer than six and no greater than twelve nubs may be included in alternate embodiments.

The nubs 36 are especially critical as rear leg flap 38 of griddle 14 provides the unit with an intentional forward tilt (slant) or angle α (in FIG. 5) of at least about 5 degrees, preferably about 7 to 15 degrees, and most preferably about 12 degrees elevated (or upwardly slanted from front edge 34 to rear edge 40). At an angle greater than that, food may slide too far forward and off the griddle while being cooked. Less than 5 degrees and the fat/grease may not sufficiently drain into tray 32. In alternate versions (not shown), rear flap 38 may be replace with two or more individual rear leg supports.

Note that the cooking surface of griddle 14 includes an inwardly curved, or scalloped edge 42. It is meant to synchronize, in shape and relative height, with the drain tray 32 on main frame element 26.

To better support and virtually “lock” griddle 14 onto main frame element 26, preferred embodiments of griddle 14 include a downwardly curving flap 44L and 44R at both forward most corners with the lowest, forward most tip of those flaps each terminating in an upwardly scalloped recess 46L and 46R that is designed to rest on respective grate ends 24 of main frame element 26.

While the overall shape of drain tray 32 resembles half of an oval or crescent, it is understood that alternate configurations for a fat/grease collection unit can also resemble a polygon, rectangle, rhomboid or other suitable (synchronize-able) shape.

The lid 16 of adapter 10 has an overall rectangular shape for generally synchronizing with the non-handled section of main frame element 26. It is internally domed and includes a forward most overhang 48 (or “overbite”) at front lid edge 50 of between about 1.5 to 2.5 inches at its maximum width W as seen in FIG. 11. More preferably, a lid overhang of about 2 inches accommodates a sufficient flow of hot air from the gas/electric burner over which it is situated for some convection cooking of the food being prepared on griddle component 14.

Still other features of lid 16 include two or more hinges 52 at a back lid edge 54 for permanently connecting to a rear edge 38 of griddle 14 at griddle hinge points 62. In an alternative variation (not otherwise shown), these hinges can be made for temporary attachment to the griddle so that the adapter can be further disassembled for easier (i.e., dishwasher) cleaning of component parts.

In the outer face 56 of lid 16, there is included a temperature gauge 58 and thereabout a lid lifting handle 60 (made from coiled metal as shown). In an alternative embodiment, that lifting handle can be made from ceramic, composite or other heat-resistant material.

The unique convective elements of adapter 10 are the shaping of hot air flow by the lid 16, and the assurance of convective heat transfer from the griddle 14 to food items placed thereon. It can be appreciated that adapter 10 provides the ability to perform direct contact grilling of food items in a variety of contexts, such as indoors on a conventional stove, in a convenient and efficient manner. The easily removable under frame and griddle employ enclosed heat for cooking food items simultaneously or separately. The grilling surface of this adapter imparts a desirable texture and appearance to grilled food items while providing for controlled drainage of undesired liquids into drain tray 32.

Many modifications of this invention are possible in light of the above teaching. The wire grid, for example, could be supported by legs within the base, and might be raised or lowered atop the stove burners. The shapes and dimensions of various parts can also be modified without departing from the spirit and scope of the invention. It is believed that the foregoing description conveys the best understanding of the objects and advantages of the present invention. Different embodiments may be made of the inventive concept of this invention. It is to be understood that all matter disclosed herein is to be interpreted merely as illustrative, and not in a limiting sense, except as set forth in the following claims.

What is claimed is:

1. A non-electric adapter for cooking food over one or more electric or gas burners, said adapter comprising:
(i) a base frame having a substantially rectangular shape with side handles at opposed ends, said base frame including a plurality of vertical wire rods, a left and right grate end rod and a forward curved rod for holding a drip tray;
(ii) a griddle having a flat upper surface onto which food is placed for cooking, said griddle having:
a. a plurality of rear leg supports that allow the griddle to stay slanted at least about 5 degrees from planar when used for cooking,
b. a plurality of nubs along a front edge for preventing food from sliding too far forward and possibly off the front edge of the griddle; and
c. a flap at each front edge corner, said flap having an upwardly curved recess for allowing the front edge of the griddle to at least rest on a grate end rod of the base frame; and
(iii) a cover lid that at least temporarily hingedly connects to a rear edge of the griddle and having a forward most edge that overlaps the front edge of the griddle by at least about 1.5 inches at its maximum width when lowered over the griddle for cooking.

2. The adapter of claim 1 wherein the griddle is slanted about 7 to 15 degrees from planar.

3. The adapter of claim 2 wherein the griddle is slanted about 12 degrees from planar.

4. The adapter of claim 1 wherein the griddle contains no fewer than six spaced nubs.

5. The adapter of claim 1 wherein the griddle contains no more than twelve spaced nubs.

6. The adapter of claim 1 wherein the cover lid is permanently hinged to a rear edge of the griddle.

7. The adapter of claim 1 wherein the cover lid overlaps the front edge of the griddle by less than about 2.5 inches at its maximum width.

8. The adapter of claim 7 wherein the cover lid overlaps the front edge of the griddle by about 2 inches.

9. The adapter of claim 1 wherein the cover lid further includes at least one of (a) a temperature gauge; and (b) a lifting handle.

10. A non-electric, non-steaming adapter for cooking food over a plurality of burners to an electric or gas stove, said adapter comprising:
(i) a base frame having a substantially rectangular shape with side handles at opposed ends, said base frame including a plurality of vertical wire rods, a left and right grate end rod and a forward curved rod for holding a drip tray;
(ii) a griddle having a flat upper surface onto which food is placed for cooking, said griddle having:
d. a plurality of rear leg supports that allow the griddle to stay slanted between about 7 to 15 degrees from planar when used for cooking,
e. at least six spaced nubs along a front edge for preventing food from sliding too far forward and possibly off the front edge of the griddle; and
f. a flap at each front edge corner, said flap having an upwardly curved recess for allowing the front edge of the griddle to at least rest on a grate end rod of the base frame; and
(iii) a cover lid permanently hinged to a rear edge of the griddle, said cover lid having a forward most edge that overlaps the front edge of the griddle by about 1.5 to 2.5 inches at its maximum width when lowered over the griddle.

11. The adapter of claim 10 wherein the griddle is slanted about 12 degrees from planar.

12. The adapter of claim 10 wherein the cover lid overlaps the front edge of the griddle by about 2 inches.

13. The adapter of claim 10 wherein the cover lid further includes a temperature gauge.

14. The adapter of claim 10 wherein the cover lid further includes a lifting handle.

15. A method for cooking food on a burner of an indoor gas or electric stove to achieve an outdoor grilling taste and appearance, said method comprising the steps of:
(a) providing a non-electric adapter comprising: (i) a base frame having a substantially rectangular shape with side handles at opposed ends, said base frame including a plurality of vertical wire rods, a left and right grate end rod and a forward curved rod for holding a drip tray; (ii) a griddle having a flat upper surface onto which food is placed for cooking, said griddle having: a plurality of rear leg supports that allow the griddle to stay slanted between about 7 to 15 degrees from planar when used for cooking, at least six spaced nubs along a front edge for preventing food from sliding too far forward and possibly off the front edge of the griddle; and a flap at each front edge corner, said flap having an upwardly curved recess for allowing the front edge of the griddle to at least rest on a grate end rod of the base frame; and (iii) a cover lid permanently hinged to a rear edge of the griddle, said cover lid having a forward most edge that overlaps the front edge of the griddle by about 1.5 to 2.5 inches at its maximum width when lowered over the griddle;
(b) positioning the adapter over the burner of an indoor gas or electric stove;
(c) raising the cover lid of the adapter to expose the griddle;
(d) positioning the food on the griddle of the adapter; and
(e) lowering the cover lid of the adapter over the food on the griddle.

16. The method of claim 15 wherein step (b) comprises positioning the adapter over two adjacent side-by-side burners of the gas or electric stove.

17. The method of claim 15 wherein step (b) comprises positioning the adapter over an adjacent front and rear burner of the gas or electric stove.
